(19) United States
(12) Patent Application Publication
(10) Pub. No.: US 2002/0149727 A1
(43) Pub. Date: Oct. 17, 2002

(54) Ferroelectric liquid crystal display and method of manufacturing the same

(75) Inventor: Jong-min Wang, Seoul (KR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: SAMSUNG ELECTRONICS CO., LTD.

(21) Appl. No.: 10/020,174

(22) Filed: Dec. 18, 2001

(30) Foreign Application Priority Data
Apr. 11, 2001 (KR) 2001-19183

(51) Int. Cl. G02F 1/1337

(52) U.S. Cl. 349/123

(57) ABSTRACT

A ferroelectric liquid crystal display including an upper base plate and a lower base plate which are disposed apart from each other at a predetermined distance, electrode layers respectively formed on the upper base plate and the lower base plate facing each other, orientation layers respectively formed on the electrode layers and treated by rubbing in a first rubbing direction and a second rubbing direction which intersect at a predetermined angle, and a liquid crystal layer disposed between the orientation layers and filled with a ferroelectric liquid crystal having a bookshelf structure. Due to the ferroelectric liquid crystal display and the method of manufacturing the same, the ferroelectric liquid crystal of the bookshelf structure can stably twist by the treatment of the orientation such that an afterimage phenomenon is prevented and further a low threshold voltage and a bistability can be obtained.

### BACKGROUND OF THE INVENTION

1. Field of the Invention

The present invention relates to a ferroelectric liquid crystal display and a method of manufacturing the same and, more particularly, to a ferroelectric liquid crystal display which has a bistability and a high contrast ratio by making use of a ferroelectric liquid crystal of a bookshelf structure.

2. Description of the Related Art

A generally used ferroelectric liquid crystal display uses liquid crystal material of a chiral smectic-C (SmC*) having a chevron structure.

The ferroelectric liquid crystal display, which uses such liquid crystal material, is manufactured in a process that, if a pertinent liquid crystal is injected into the ferroelectric liquid crystal display and then the temperature is decreased, the ferroelectric liquid crystal is sequentially transformed to a chiral nematic phase (N*), a smectic-A having a layer structure perpendicular to a rubbing direction, and again the chiral smectic-C. During the process, a major axis of a liquid crystal molecule within a liquid crystal layer twists at a predetermined angle with respect to the rubbing direction such that a gap between the smectic layers is decreased. Thus, as shown in FIG. 1, a smectic layer within a liquid crystal layer 10 bends in order to compensate for the change of the volume. Such a bent layer structure is called the chevron structure that has domains in which major axes directions of liquid crystals are different to each other depending on a bending direction, and an unequal orientation is obtained due to a zigzag connection on a boundary surface between the domains, a hair pin defect, and a mountain defect.

Due to the characteristic of the orientation, the contrast ratio of the liquid crystal display is remarkably decreased. If a direct current voltage is supplied to prevent the decrease of the contrast ratio, ions on the liquid crystal layer are stacked on an orientation layer, which causes an afterimage phenomenon. That is, there is a problem in that an image of a prior display remains dimly even after the prior display status is transferred to another display status.

### SUMMARY OF THE INVENTION

The present invention is developed in order to solve the above problem, and an aspect of the present invention is to provide a ferroelectric liquid crystal display that has a bistability and a high contrast ratio and a method of manufacturing the same.

According to the present invention, a ferroelectric liquid crystal display comprises an upper base plate and a lower base plate which are disposed apart from each other at a predetermined distance, electrode layers respectively formed on the upper base plate and the lower base plate facing each other, orientation layers respectively formed on the electrode layers, and a liquid crystal layer disposed between the orientation layers and filled with a ferroelectric liquid crystal, wherein the liquid crystal layer is formed of the ferroelectric liquid crystal having a bookshelf structure and the respective orientation layers are treated by rubbing in a first rubbing direction and a second rubbing direction which intersect at a predetermined angle.

Preferably, but not necessarily, the second rubbing direction intersects with the first rubbing direction at an angle of 45°.

Also, in order to achieve the above aspects, a method of manufacturing the ferroelectric liquid crystal display includes the steps of forming a lower structure and an upper structure respectively in which base plates, electrode layers, and orientation layers are sequentially formed therein, treating the orientation layers by rubbing in a first rubbing direction, treating the orientation layers by rubbing in a seconding rubbing direction which intersects with the first rubbing direction at a predetermined angle, forming a cell for injecting a ferroelectric liquid crystal on one of the lower structure and the upper structure treated by the rubbing; connecting the lower structure with the upper structure, and injecting the ferroelectric liquid crystal having a bookshelf structure into the cell between the lower structure and the upper structure and then sealing an injecting port.

### BRIEF DESCRIPTION OF THE DRAWING

The above aspects and characteristics of the present invention will become more apparent by describing an illustrative embodiment of the present invention in detail with reference to accompanying drawings, in which:

FIG. 1 is a schematic view showing a liquid crystal layer of a chevron structure;

FIG. 2 is a cross sectional view showing a ferroelectric liquid crystal display according to the present invention;

FIG. 3 is a view showing an orientation layer of FIG. 2 treated by rubbing;

FIG. 4 is a schematic view showing an arrangement of a ferroelectric liquid crystal of a bookshelf structure of FIG. 3;

FIG. 5 is a view showing a twist angle of the ferroelectric liquid crystal depending on supply of an electric filed; and

FIG. 6 is a flowchart showing a process of manufacturing a ferroelectric liquid crystal display according to the present invention.

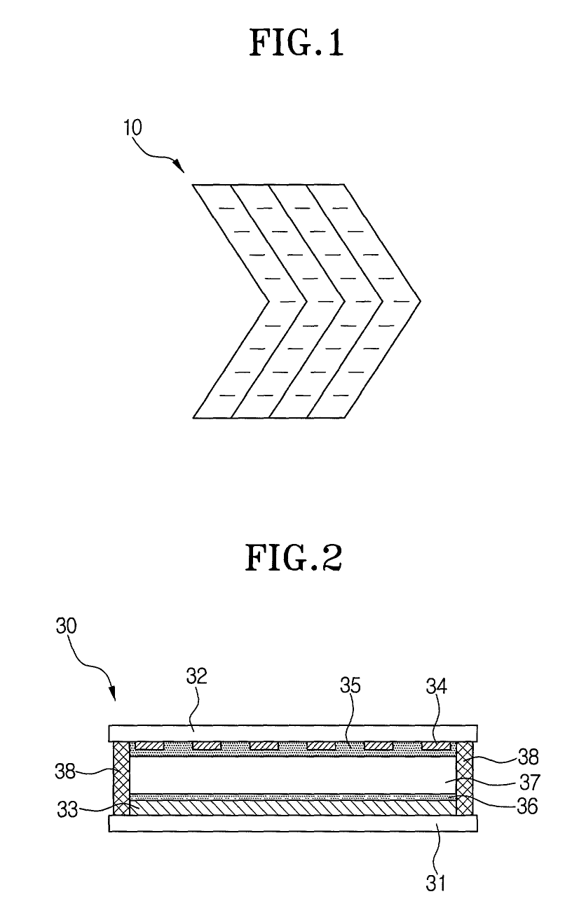

### DETAILED DESCRIPTION OF THE ILLUSTRATIVE EMBODIMENT

Hereinafter, a ferroelectric liquid crystal display and a method of manufacturing the same is described in greater detail in accordance with an illustrative and non-limiting embodiment of the present invention with reference to the accompanying drawings.

FIG. 2 is a cross sectional view showing a ferroelectric liquid crystal display in accordance with the present invention.

Referring to FIG. 2, the ferroelectric liquid crystal display 30 comprises a lower base plate 31, a lower electrode layer 33, a lower orientation layer 36, a liquid crystal layer 37, an upper orientation layer 35, an upper electrode layer 34, an upper base plate 32, and a sealing element 38. At non-facing external sides of the lower base plate 31 and the upper base plate 32, polarizing plates (not illustrated) are arranged.

The upper and lower base plates 32 and 31 are made of a transparent material such as glass.

The upper and lower electrode layers 34 and 33 are made of a transparent and conductive material such as an indium tin oxide (ITO) material. Preferably, a plurality of electrodes are arranged on the lower electrode layer 33 and the upper electrode layer 34 in lines intersecting at a right angle.

The upper and lower orientation layers 35 and 36 are made of various generally known orientation materials such as, for example, a polyimide, a polyvinyl alcohol, nylon, a kind of polyvinyl alcohol (PVA), and etc.

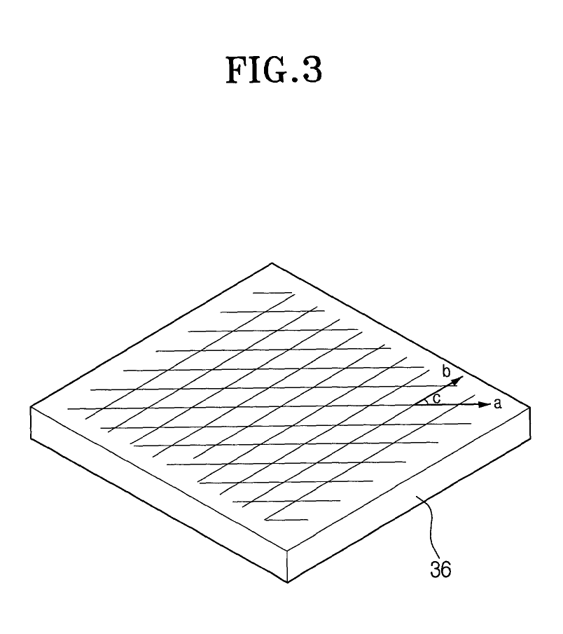

As shown in FIG. 3, the orientation layers 35 and 36 are treated by rubbing both in a first rubbing direction of “a” and in a second rubbing direction of “b” which intersect at a predetermined angle. An intersecting angle “c” between the first rubbing direction “a” and the second rubbing direction “b” corresponds to a twist angle of an employed ferroelectric liquid crystal material. For example, if the twist angle of the employed ferroelectric liquid crystal material is 45°, it is preferable that the intersecting angle “c” between the first and second rubbing directions “a” and “b” is determined to be 45°. The rubbing treatment of the intersecting directions on the orientation layer stably provides the characteristic of the orientation by corresponding to the twist angle generated from the supply of the electric field to the employed liquid crystal material.

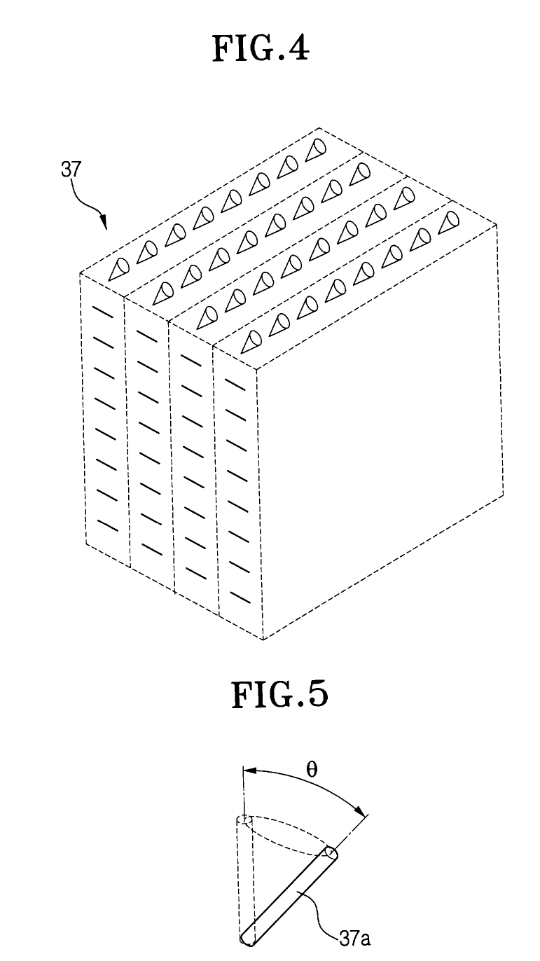

The liquid crystal layer 37 is filled with the ferroelectric liquid crystal material of the bookshelf structure. As shown in FIG. 4, the ferroelectric liquid crystal layer 37 of the bookshelf structure has a structure in which liquid crystal molecules are arranged on the smectic layers in lines without bending, the smectic layers being vertically arranged after a process of injecting and a phase transforming. The ferroelectric liquid crystal material of the bookshelf structure is transformed from a chiral nematic phase (N*) and then directly to a chiral smectic-C (SmC*) having a layer structure perpendicular to the rubbing direction if a pertinent liquid crystal is injected and the temperature is decreased.

The liquid crystal material of the bookshelf structure is disclosed in various documents, for example, the Japanese Patents Nos. 6-122875 & 6-25060 & 6-40985 & 6-228057, and Korean Patent No. 1997-1332.

As described above, if the orientation layers 35 and 36 are treated by rubbing both in the first and the second rubbing directions “a” and “b” which intersect at the predetermined angle “c” corresponding to the twist angle of the liquid crystal material, then a surface energy is changed relatively according to the respective rubbing directions such that the orientation of the liquid crystal material is stably accomplished corresponding to the twist angle. As a result, as shown in FIG. 5, a liquid crystal molecule 37a is stably maintained within a range of twist angle θ at which a liquid crystal molecule 37a repeatedly twists parallel to a surface of the orientation layer whenever the voltage is supplied. Accordingly, an excellent bistability can be obtained, the driving voltage can be reduced due to the low threshold voltage, and the contrast ratio can be increased.

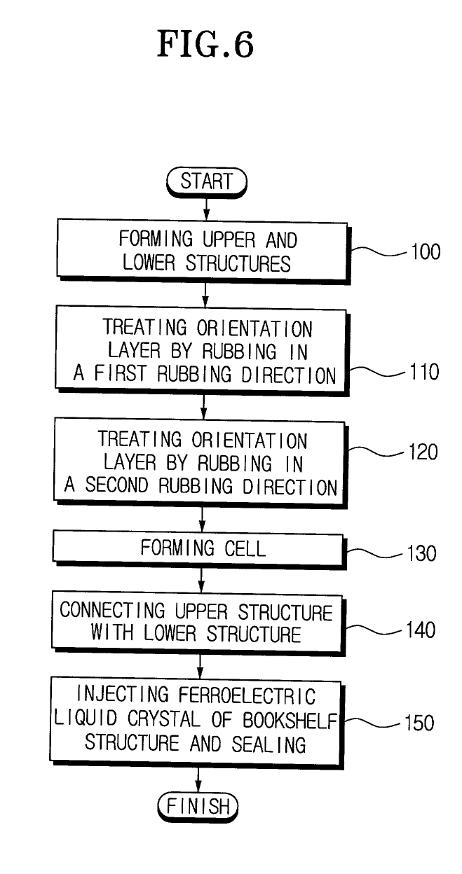

The process of manufacturing the liquid crystal display will be described referring to FIG. 6.

First, upper and lower structures are formed (Step 100). The lower structure is comprised of the lower base plate 31, the lower electrode layer 33, and the lower orientation layer 36 sequentially formed, and the upper structure is comprised of the upper base plate 32, the upper electrode layer 34, and the upper orientation layer 35 sequentially formed.

Next, the upper and lower orientation layers 35 and 36 are treated by rubbing in the first rubbing direction (Step 110), and then treated by rubbing in the second rubbing direction (Step 120).

Various generally known methods may be employed for rubbing such as, for example, a method of rubbing surfaces of the orientation layers 35 and 36 with a roller on which cloth is wound.

Next, sealing material such as a sealant is printed on the base plate 31 or 32 of one of the lower structure and the upper structure, which are treated by rubbing, to form a cell structure (Step 130). Then, a spacer is installed for maintaining a predetermined distance between the upper and lower structures and then the one structure having the printed base plate is connected to the other structure (Step 140).

After the connection, the ferroelectric liquid crystal of the bookshelf structure is injected into the cell formed by the sealing material and then an injecting port of the cell is sealed (Step of 150). After that, a temperature treatment is performed to obtain a chiral smectic phase of the bookshelf structure.

As described above, in the ferroelectric liquid crystal display and the method of manufacturing the same according to the present invention, the ferroelectric liquid crystal of the bookshelf structure can stably twist by the treatment of the orientation such that the afterimage phenomenon is prevented and further the low threshold voltage and the bistability can be obtained.

Although an illustrative embodiment of the present invention has been described, it will be understood by those skilled in the art that the present invention should not be limited to the described illustrative embodiment, but various changes and modifications can be made within the spirit and scope of the present invention as defined by the appended claims.

What is claimed is:

1. A ferroelectric liquid crystal display comprising:
an upper base plate and a lower base plate which are disposed apart from each other at a predetermined distance;
electrode layers respectively formed on the upper base plate and the lower base plate facing each other;
orientation layers respectively formed on the electrode layers; and
a liquid crystal layer disposed between the orientation layers and filled with a ferroelectric liquid crystal,
wherein the liquid crystal layer is formed of the ferroelectric liquid crystal having a bookshelf structure and the respective orientation layers are treated by rubbing in a first rubbing direction and a second rubbing direction which intersect at a predetermined angle.

2. The ferroelectric liquid crystal display of claim 1, wherein the second rubbing direction intersects with the first rubbing direction at an angle of 45°.

3. A method of manufacturing the ferroelectric liquid crystal display, the method comprising:
forming a lower structure and a upper structure respectively in which base plates, electrode layers, and orientation layers are sequentially formed therein;
treating the orientation layers by rubbing in a first rubbing direction;
treating the orientation layers by rubbing in a seconding rubbing direction which intersects with the first rubbing direction at a predetermined angle;
forming a cell for injecting a ferroelectric liquid crystal on one of the lower structure and the upper structure treated by the rubbing;
connecting the lower structure with the upper structure; and
injecting the ferroelectric liquid crystal having a bookshelf structure into the cell between the lower structure and the upper structure and then sealing an injecting port.
